(19) United States
(12) Patent Application Publication
(10) Pub. No.: US 2023/0042177 A1
(43) Pub. Date: Feb. 9, 2023

(54) ELECTRONIC DEVICE, WIRELESS COMMUNICATION METHOD, AND COMPUTER-READABLE STORAGE MEDIUM

(71) Applicant: Sony Group Corporation, Tokyo (JP)

(72) Inventors: Youping ZHAO, Beijing (CN); Yifei LIANG, Beijing (CN); Chen SUN, Beijing (CN); Zhong TIAN, Beijing (CN)

(73) Assignee: Sony Group Corporation, Tokyo (JP)

(21) Appl. No.: 17/793,414

(22) PCT Filed: Feb. 23, 2021
(86) PCT No.: PCT/CN2021/077330

§ 371 Date: Jul. 18, 2022

(30) Foreign Application Priority Data
Mar. 2, 2020 (CN) 202010134965.5

(51) Int. Cl. H04W 72/08; H04W 72/04

(52) U.S. Cl. CPC H04W 72/082; H04W 72/0453

(57) ABSTRACT

An electronic device, a wireless communication method, and a computer-readable storage medium. The electronic device according to the present disclosure comprises a processing circuit, which is configured to: determine a credit value of a user equipment according to the channel quality of the user equipment and interference caused by the user equipment to other user equipments in a predetermined range; and determine, according to the credit value of the user equipment, whether to limit the usage of a spectrum of the user equipment. By means of the electronic device, the wireless communication method, and the computer-readable storage medium of the present disclosure, a spectrum usage behavior of a user equipment during a spectrum sharing process can be quantitatively evaluated, so as to manage and control a behavior of the user equipment in a streamlined manner, reduce inter-user-equipment interference, and improve the total utility of a system.

This application claims priority to Chinese Patent Application No. 202010134965.5, titled “ELECTRONIC DEVICE, WIRELESS COMMUNICATION METHOD, AND COMPUTER-READABLE STORAGE MEDIUM”, filed on Mar. 2, 2020 with the Chinese Patent Office, which is incorporated herein by reference in its entirety.

### FIELD

The present disclosure generally relates to the field of wireless communication, and in particular to an electronic device, a wireless communication method, and a computer-readable storage medium. More specifically, the present disclosure relates to an electronic device as a spectrum management device in a wireless communication system, a wireless communication method performed by a spectrum management device in a wireless communication system, and a computer-readable storage medium.

### BACKGROUND

With the continuous development of wireless communication technologies, a wireless network access scenario becomes complex and heterogeneous. Shortage of spectrum resources is becoming increasingly prominent, and how to realize efficient spectrum sharing has become a key problem in improving network capacity and ensuring massive connections.

In a process of spectrum sharing in a heterogeneous network, considering heterogeneity of the network, a spectrum sharing mechanism based on game theory is usually adopted. Specifically, the three elements of a game model are matched to elements in spectrum sharing in one-to-one correspondence: a player corresponds to a user equipment bidding for a spectrum; a strategy set corresponds to selections by each user equipment for a transmission parameter (such as channel selection and power distribution); and a utility function corresponds to a non-decreasing function of the quality of service to be obtained by using a channel. However, in the process of spectrum sharing in the heterogeneous network, each user equipment makes a decision only for maximizing the utility function for itself, and therefore it is difficult to suppress a selfish behavior of the user equipment in the process of spectrum sharing. This problem is highlighted with a network structure becoming complicated and heterogeneous and an explosive growth of the quantity of user equipment.

Therefore, it is required to propose a technical solution, by which a quantitative evaluation is performed on a spectrum use behavior of a user equipment in a process of spectrum sharing, in order to realize refined management and control on a behavior of the user equipment, thereby reducing interference between the user equipments and improving an overall system utility.

### SUMMARY

A general summary of the present disclosure is provided in this section, which is not a comprehensive disclosure of the full scope or all features of the present disclosure.

An objective of the present disclosure is to provide an electronic device, a wireless communication method and a computer-readable storage medium, in order to perform an quantitative evaluation on a spectrum use behavior of a user equipment in a process of spectrum sharing, so as to realize refined management and control on a behavior of the user equipment, thereby reducing interference between the user equipments and improving an overall system utility.

According to an aspect of the present disclosure, an electronic device is provided. The electronic device includes processing circuitry, which is configured to: determine a credit value of a user equipment based on channel quality of the user equipment and interference caused by the user equipment to other user equipment within a predetermined range; and determine, based on the credit value of the user equipment, whether to restrict spectrum use of the user equipment.

According to another aspect of the present disclosure, a wireless communication method is provided. The wireless communication method includes: determining a credit value of a user equipment based on channel quality of the user equipment and interference caused by the user equipment to other user equipment within a predetermined range; and determining, based on the credit value of user equipment, whether to restrict spectrum use of the user equipment.

According to another aspect of the present disclosure, a computer-readable storage medium including executable computer instructions is provided. The executable computer instructions, when executed by a computer, cause the computer to perform the wireless communication method according to the present disclosure.

According to another aspect of the present disclosure, a computer program is provided. The computer program, when executed by a computer, causes the computer to perform the wireless communication method according to the present disclosure.

With the electronic device, the wireless communication method, and the computer-readable storage medium according the present disclosure, a credit value of a user equipment may be determined based on channel quality of the user equipment and interference caused by the user equipment to other user equipment within a predetermined range, and then it may be determined, based on the credit value, whether to restrict spectrum use behavior of the user equipment. In this way, a quantitative evaluation may be performed on the spectrum use behavior of the user equipment, and the spectrum use behavior of the user equipment may be managed and controlled so as to reduce interference between the user equipments and improve an overall system utility.

Further areas of applicability will become apparent from the description provided herein. The description and specific examples in this summary are for illustrative purposes only, and are not intended to limit the scope of the present disclosure.

### BRIEF DESCRIPTION OF THE DRAWINGS

The drawings are described herein for illustrating selected embodiments rather than all possible embodiments, and are not intended to limit the scope of the present disclosure. In the drawings:

FIG. 1 is a schematic diagram showing a scenario according to an embodiment of the present disclosure;

FIG. 2 is a block diagram showing an exemplary configuration of an electronic device according to an embodiment of the present disclosure;

FIG. 3 is a schematic diagram showing a process of determining a punishment according to an embodiment of the present disclosure;

FIG. 4 is a schematic diagram showing a relationship between a punishment setting coefficient and user density according to an embodiment of the present disclosure;

FIG. 5 is a diagram showing a signaling flow in a process of spectrum management according to an embodiment of the present disclosure;

FIG. 6 is a flowchart showing a wireless communication method performed by an electronic device according to an embodiment of the present disclosure;

FIG. 7 is a schematic diagram showing a simulation scenario according to an embodiment of the present disclosure;

FIG. 8 is a schematic diagram showing a simulation curve of the maximum number of connections in the system versus the number of iterations of an algorithm according to an embodiment of the present disclosure;

FIG. 9 is a schematic diagram showing simulation curves of a cumulative distribution function of signal to interference plus noise ratio of user equipment according to an embodiment of the present disclosure;

FIG. 10 is a block diagram showing an example of a server that may implement the electronic device 200 according to the present disclosure;

FIG. 11 is a block diagram showing a first example of a schematic configuration of an eNB (Evolved Node B); and

FIG. 12 is a block diagram showing a second example of a schematic configuration of an eNB.

Although the present disclosure is susceptible to various modifications and alternatives, specific embodiments of the present disclosure are shown in the drawings by way of examples and are described in detail herein. However, it should be understood that description of the specific embodiments herein is not intended to limit the present disclosure to the specific forms disclosed, but to cover all modifications, equivalents and alternatives that fall within the spirit and scope of the present disclosure. It should be noted that same or similar reference numerals throughout the drawings indicate the same or like components.

### DETAILED DESCRIPTION

The embodiments of the present disclosure are described completely with reference to the drawings. The following description is merely exemplary, and is not intended to limit the present disclosure and application or use thereof.

Exemplary embodiments are provided so that the present disclosure is thorough and fully convey the scope thereof to those skilled in the art. Numerous specific details, such as examples of specific components, devices, and methods, are set forth to provide a comprehensive understanding of the embodiments of the present disclosure. It is apparent to those skilled in the art that the exemplary embodiments may be implemented in many different forms without specific details, and should be construed as limiting the scope of the present disclosure. In some exemplary embodiments, well-known processes, well-known structures, and well-known technologies are not described in detail.

The description are made in the following order:

1. Description of a scenario;
2. Configuration examples of an electronic device;
3. Method embodiments;
4. Simulation results; and
5. Application examples.

### 1. DESCRIPTION OF A SCENARIO

FIG. 1 is a schematic diagram showing an application scenario according to an embodiment of the present disclosure. As shown in FIG. 1, there are multiple UEs (user equipment) within a coverage of a BS (Base Station), where CUEs numbered from 1 to m each represent a cellular user equipment which communicates with the BS through a direct link there between, and DUEs numbered from 1 to m each represent a D2D (Device To Device) user equipment which communicates with another D2D user equipment in a D2D manner. In a case that each user equipment considers only maximization of its own utility function in a process of spectrum use, interference may be caused to other user equipment. For example, dashed arrows in FIG. 1 show examples of interference.

According to the present disclosure, an electronic device in a wireless communication system, a wireless communication method performed by an electronic device in a wireless communication system, and a computer-readable storage medium are provided for such scenario, in order to perform quantitative evaluation on spectrum use behavior of a user equipment in a spectrum sharing process, and thereby realize refined management and control on a behavior of the user equipment.

The wireless communication system according to the present disclosure may be a 5G NR (New Radio) communication system.

The electronic device according to the present disclosure is capable of performing spectrum management, such as channel allocation for user equipment and control of a spectrum use behavior of the user equipment, so as to avoid or reduce a selfish behavior or misconduct of the user equipment in the process of spectrum use. Therefore, the electronic device is also referred to as a spectrum management device herein.

The spectrum management device may be implemented as any type of server, such as a tower server, a rack server, or a blade server. The electronic device 200 may be a control module mounted on a server (such as an integrated circuit module including a single wafer, and a card or blade inserted into a slot of a blade server).

The spectrum management device may be disposed in a network side device. The network side device described in the present disclosure may be a base station device, such as an eNB or gNB (which is a base station in the 5th generation communication system).

The user equipment according to the present disclosure may be a mobile terminal (such as a smartphone, a tablet personal computer (PC), a notebook PC, a portable game terminal, a portable/dongle mobile router, and a digital camera), or a in-vehicle terminal (such as a car navigation device). The user equipment may be implemented as a terminal for machine-to-machine (M2M) communication (also referred to as a machine type communication (MTC) terminal). In addition, the user equipment may be a wireless communication module (such as an integrated circuit module including a single wafer) installed on each of the aforementioned terminals.

### 2. CONFIGURATION EXAMPLES OF AN ELECTRONIC DEVICE

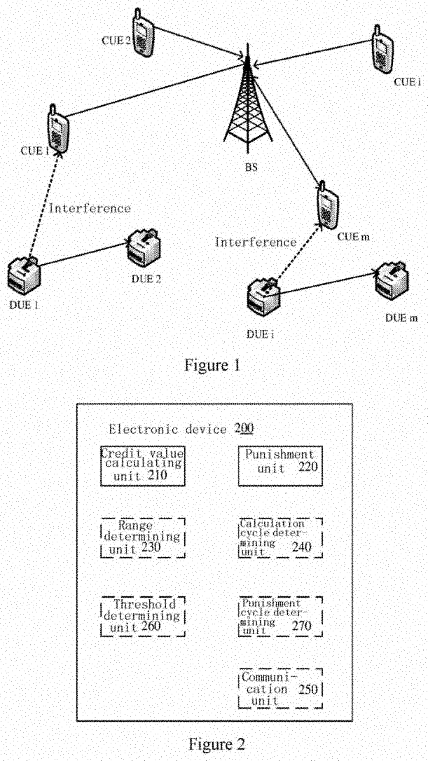

FIG. 2 is a block diagram showing an exemplary configuration of an electronic device 200 according to an embodiment of the present disclosure. The electronic device 200 here may serve as a spectrum management device in a wireless communication system.

As shown in FIG. 2, the electronic device 200 may include a credit value calculating unit 210 and a punishment unit 220.

Here, each unit of the electronic device 200 may be included in processing circuitry. It should be noted that the electronic device 200 may include a single processing circuit or multiple processing circuits. Further, the processing circuitry may include various discrete functional units to perform various different functions and/or operations. It should be noted that these functional units may be physical entities or logical entities, and units with different names may be implemented by a same physical entity.

According to an embodiment of the present disclosure, the credit value calculating unit 210 may be configured to determine a credit value of a user equipment based on channel quality of the user equipment and interference caused by the user equipment to other user equipment within a predetermined range.

According to an embodiment of the present disclosure, the punishment unit 220 may be configured to determine, based on the credit value of the user equipment, whether to restrict spectrum use of the user equipment.

It can be seen that, with the electronic device 200 according to an embodiment of the present disclosure, a credit value of a user equipment may be determined based on channel quality of the user equipment and interference caused by the user equipment to other user equipment within a predetermined range, and then it may be determined, based on the credit value, whether to restrict spectrum use behavior of the user equipment. In this way, a quantitative evaluation may be performed on the spectrum use behavior of the user equipment, and therefore the spectrum use behavior of the user equipment is managed and controlled, and may be restricted if necessary, that is, the user equipment may be punished.

Here, the user equipment may be any user equipment within a spectrum management range of the electronic device 200. That is, the electronic device 200 may be configured to calculate a credit value of any user equipment within the spectrum management range of the electronic device 200, and thereby determine whether to restrict the spectrum use of the user equipment.

According to an embodiment of the present disclosure, the credit value calculating unit 210 may be configured to calculate the credit value of the user equipment in each credit value determination cycle. Further, the credit value calculating unit 210 may be configured to determine the credit value in a current credit value determination cycle based on the credit value in a previous credit value determination cycle.

According to an embodiment of the present disclosure, the credit value calculating unit 210 may be configured to determine a decrease value of the credit value based on the channel quality of the user equipment and the interference caused by the user equipment to other user equipment within the predetermined range, and determine the credit value of the user equipment in a current credit value determination cycle based on the credit value of the user equipment in a previous credit value determination cycle and the decrease value.

For example, the credit value calculating unit 210 may be configured to calculate the credit value Crᵢ of the user equipment in an i-th (where i is a positive integer) credit value determination cycle according to the following equation:

Crᵢ=Crᵢ₋₁−Cr_{decrease} (1)

Where Crᵢ₋₁ represents the credit value of the user equipment in the (i−1)th credit value determination cycle, that is, the credit value in the previous credit value determination cycle, and Cr_{decrease} represents the decrease value of the credit value determined based on the channel quality of the user equipment and the interference caused by the user equipment to other user equipment within the predetermined range.

According to an embodiment of the present disclosure, the credit value calculating unit 210 may determine an initial value Cr₀ of the credit value of the user equipment based on at least one of the following parameters of the user equipment: a transmission distance, a transmission power, and a traffic type.

According to an embodiment of the present disclosure, the transmission distance represents a distance between an information sender and an information receiver. The information sender may be the user equipment, and the information receiver may be another user equipment or base station device. The credit value calculating unit 210 may determine an initial value of the credit value directly proportional to the transmission distance, that is, a greater transmission distance indicates a greater initial value of the credit value.

According to an embodiment of the present disclosure, the transmission power represents a transmission power of the user equipment serving as the information sender. The credit value calculating unit 210 may determine the initial value of the credit value directly proportional to the transmission power, that is, a greater transmission power indicates a greater initial value of the credit value.

According to an embodiment of the present disclosure, the traffic type represents a traffic type of information to be sent by the user equipment. The credit value calculating unit 210 may determine the initial value of the credit value directly proportional to a priority of the traffic type, that is, a higher priority of the traffic type indicates a higher initial value of the credit value.

According to an embodiment of the present disclosure, the credit value calculating unit 210 may comprehensively consider at least one of the transmission distance, the transmission power, and the traffic type when determining the initial value of the credit value. The initial value of the credit value may be directly proportional to the transmission distance, the transmission power and/or a priority of the traffic type. In another example, the credit value calculating unit 210 may perform a weighting operation on at least one of the transmission distance, the transmission power, and the traffic type, to determine the initial value of the credit value. In this way, effect of an excessive decrease value of the credit value caused by large interference to other user equipment due to long transmission distance and high transmission power may be eliminated, and a traffic having high priority may be guaranteed.

As shown in FIG. 2, according to an embodiment of the present disclosure, the electronic device 200 may further include a communication unit 250 for receiving information from and sending information to other equipment other than the electronic device 200.

According to an embodiment of the present disclosure, the electronic device 200 may receive state information of the user equipment from the user equipment through the communication unit 250. Here, the state information of the user equipment may include a location of the user equipment, a transmission power of the user equipment, a traffic type of the user equipment, and other parameters. For example, the user equipment may periodically report the state information of the user equipment to the electronic device 200, so that the electronic device 200 may determine an initial value of the credit value of the user equipment based on the information reported by the user equipment.

A method for determining a decrease value Cr_{decrease} of the credit value is described in detail below.

According to an embodiment of the present disclosure, the credit value calculating unit 210 may determine a channel quality difference based on a difference between the channel quality of the user equipment and a channel quality threshold of the user equipment; and determine the decrease value of the credit value of the user equipment based on the channel quality difference and the interference caused by the user equipment to other user equipment within the predetermined range. That is, the decrease value of the credit value includes two parts, i.e., the channel quality difference of the user equipment, and the interference caused by the user equipment to other user equipment within the predetermined range.

According to an embodiment of the present disclosure, the credit value calculating unit 210 may determine the decrease value of the credit value by calculating a sum of the channel quality difference of the user equipment and the interference caused by the user equipment to other user equipment within the predetermined range. Further, the credit value calculating unit 210 may calculate the sum after performing a normalization operation or a weighting operation on the two parts.

According to an embodiment of the present disclosure, the electronic device 200 may receive the channel quality of the user equipment from the user equipment through the communication unit 250. Further, the electronic device 200 may determine a channel quality threshold of the user equipment based on the traffic type reported by the user equipment, where the channel quality threshold represents a lowest channel quality that meets a normal service requirement of the user equipment. Therefore, the credit value calculating unit 210 may calculate the channel quality difference by subtracting the channel quality threshold of the user equipment from the channel quality of the user equipment.

According to an embodiment of the present disclosure, the credit value calculating unit 210 may determine, based on a difference between the channel quality of the other user equipment when not suffering from the interference by the user equipment and the channel quality of the other user equipment when suffering from the interference by the user equipment, the interference caused by the user equipment to the other user equipment.

According to an embodiment of the present disclosure, the credit value calculating unit 210 may estimate the channel quality of another user equipment within the predetermined range when not suffering from the interference by the user equipment. Further, the electronic device 200 may receive, through the communication unit 250 from the another user equipment within the predetermined range, the channel quality of the another user equipment when suffering from the interference by the user equipment, so that the credit value calculating unit 210 may determine the interference caused by the user equipment to the another user equipment by subtracting the channel quality of the another user equipment when suffering from the interference by the user equipment from the channel quality of the another user equipment when not suffering from the interference by the user equipment. Further, the credit value calculating unit 210 may calculate a sum of interferences caused by the user equipment to all other user equipments to determine the interference caused by the user equipment to all other user equipments within the predetermined range.

According to an embodiment of the present disclosure, the channel quality of the user equipment and/or the channel quality of the other user equipment may be represented with various parameters, including but not limited to SIR (Signal to Interference Ratio), SINR (Signal to Interference plus Noise Ratio), and SNR (Signal Noise Ratio).

A non-limiting example of calculating the decrease value Cr_{decrease} of the credit value by the credit value calculating unit 210 is given below:

Cr_{decrease}=φ(SINR−SINRₜₕ)+φ(Σₙ₌₁^{N}SINRₙ^{initial}−SINRₙ^{after}) (2)

In the equation, SINR represents an SINR of the user equipment, SINRₜₕ represents a threshold of the SINR of the user equipment, and SINR-SINRₜh represents a channel quality difference of the user equipment; n represents a serial number, from 1 to N, of another user equipment within a predetermined range, where N indicates a total number of other user equipments within the predetermined range; SINRₙ^{initial} represents the SINR of the n-th other user equipment within the predetermined range when not suffering from the interference by the user equipment, and SINRₙ^{after} represents the SINR of the n-th other user equipment within the predetermined range when suffering from the interference by the user equipment. SINRₙ^{initial}−SINRₙ^{after} represents the interference caused by the user equipment to the n-th other user equipment. Σₙ₌₁^{N}SINRₙ^{initial}−SINRₙ^{after} represents the interference caused by the user equipment to all other user equipments within the predetermined range; and φ( ) represents a normalization operation, that is, mapping the content in parentheses to a range of [0, 1]. The following equation shows an example of a normalization function, by which the content x in parentheses may be mapped to the range of [0, 1].

$$φ ( x ) = \frac{1}{1 + {e}^{- 0.1 x}} \qquad ( 3 )$$

According to an embodiment of the present disclosure, as shown in FIG. 2, the electronic device 200 may further include a range determining unit 230 for determining a predetermined range of the user equipment, within which the user equipment may cause interference to other user equipment. The predetermined range is an area of a predetermined shape around the user equipment. For example, the predetermined range may be a circular area centered on the user equipment.

According to an embodiment of the present disclosure, the range determining unit 230 may determine a radius of the predetermined range based on a transmission power of the user equipment. For example, the range determining unit 230 may determine a radius r of the predetermined range based on the following formula:

$$r = \frac{λ}{4 π} {( \frac{S}{{P}_{TX} {G}_{RX} {G}_{TX}} )}^{- \frac{1}{α}} \qquad ( 4 )$$

In the equation, λ represents a wavelength of a signal, S represents a receiving sensitivity of a receiver, P_{TX} represents a transmission power of the user equipment, G_{RX} represents a gain of a receiving antenna, G_{TX} represents a gain of a transmitting antenna, and a represents an index of path loss.

According to an embodiment of the present disclosure, after determining the radius r of the predetermined range by the range determining unit 230 as described above, a circular area with a radius of r centered on the user equipment may be determined, and thereby all other user equipments in the circular area are determined.

As described above, according to an embodiment of the present disclosure, the decrease value of the credit value is calculated by the credit value calculating unit 210 considering not only the channel quality difference of the user equipment, which is a degree to which the channel quality of the user equipment exceeds the channel quality threshold, but also the interference caused by the user equipment to other user equipment, which is a degree of decrease of the channel quality due to the interference by the user equipment to all other user equipment within the predetermined range. Therefore, the decrease value of the credit value may be determined reasonably, and then the credit value of the user equipment may be determined reasonably.

According to an embodiment of the present disclosure, the credit value calculating unit 210 may determine, based on an actual period of spectrum use of the user equipment and a threshold period of spectrum use, a probability that the credit value in a current cycle for credit value determination is equal to the credit value in a previous cycle for credit value determination. Here, in a case that the credit value in a current cycle for credit value determination is equal to the credit value in a previous cycle for credit value determination, the credit value of the user equipment does not change regardless of the decrease value of the credit value, which may be referred to that “the user equipment is exempt”. That is, the credit value calculating unit 210 may determine a probability that the user equipment is exempted based on the actual period of spectrum use of the user equipment and the threshold period of spectrum use.

After introducing the exemption mechanism, the credit value calculating unit 210 may calculate Crᵢ, through the formula below:

Crᵢ=Crᵢ₋₁−Cr_{decrease}×λₑₓₑₘₚₜ (5)

In the equation, λₑₓₑₘₚₜ represents an exemption coefficient, and the λₑₓₑₘₚₜ equal to 0 represents that the user equipment is exempted, that is, the credit value in the i-th cycle for credit value determination is equal to the credit value in the (i−1)-th cycle for credit value determination.

According to an embodiment of the present disclosure, in a case that the actual period of spectrum use of the user equipment is greater than or equal to the threshold period of spectrum use, the credit value calculating unit 210 may determine that the probability of λₑₓₑₘₚₜ being 0 is zero. That is, in the case that the actual period of spectrum use of the user equipment is greater than or equal to the threshold period of spectrum use, the credit value calculating unit 210 may determine that the user equipment is not exempted.

According to an embodiment of the present disclosure, in a case that the actual period of spectrum use of the user equipment is less than the threshold period of spectrum use, the credit value calculating unit 210 may determine the probability of λₑₓₑₘₚₜ being 0 based on a ratio between the actual period of spectrum use of the user equipment and the threshold period of spectrum use. That is, the probability P of λₑₓₑₘₚₜ being 0 may be determined based on a formula below:

$$P ( {λ}_{exempt} = 0 ) = 1 - {( \frac{{T}_{actual}}{{T}_{required}} )}^{2} \qquad ( 6 )$$

In the equation, T_{actual} represents the actual period spectrum use of the user equipment, and T_{required} represents the threshold period of spectrum use of the user equipment.

According to an embodiment of the present disclosure, the actual period of spectrum use of the user equipment may be an actual spectrum access time for the user equipment within a predetermined time period. The predetermined time period may, for example, be equal to a punishment cycle, which will be described in detail later. The user equipment may monitor the actual period of spectrum use, and the electronic device 200 may acquire the actual period of spectrum use of the user equipment from the user equipment through the communication unit 250.

According to an embodiment of the present disclosure, the threshold period of spectrum use of the user equipment may be equal to the minimum spectrum access time required by the user equipment within the predetermined time period. According to an embodiment of the present disclosure, the credit value calculating unit 210 may determine the threshold period of spectrum use based on a traffic type reported by the user equipment. Specifically, the credit value calculating unit 210 may determine, based on the traffic type of the user equipment, the number of bits to be transmitted by the user equipment during the predetermined time period, and determine the threshold period of spectrum use based on the number of bits to be transmitted and an information transmission rate.

For example, the credit value calculating unit 210 may calculate the threshold period of spectrum use through a formula below:

$${T}_{required} = \frac{N b}{R} \qquad ( 7 )$$

In the equation, Nb represents the number of bits to be transmitted within the predetermined time period determined based on a traffic type of the user equipment, and R represents the information transmission rate under a current channel condition.

As described above, according to embodiments of the present disclosure, an exemption coefficient may be introduced, that is, there is a certain probability that the credit value in a current cycle for credit value determination is equal to the credit value in a previous cycle for credit value determination. In this way, for situations in which the credit value of user equipment is low because of great influence of the user equipment on other user equipment within a predetermined range due to a long transmission distance, a high transmission power, or other reasons, introduction of the exemption coefficient may allow a certain probability of avoiding decrease of the credit value of the user equipment, so as to avoid restrictions on the spectrum use behavior of the user equipment. Therefore, according to the embodiments of the present disclosure, fairness in spectrum sharing in a heterogeneous network may be improved.

According to an embodiment of the present disclosure, the credit value calculating unit 210 may calculate the credit value of the user equipment in each cycle for credit value determination of the user equipment.

As shown in FIG. 2, according to an embodiment of the present disclosure, the electronic device 200 may further include a calculation cycle determining unit 240 for determining a cycle for credit value determination of the user equipment.

According to an embodiment of the present disclosure, the calculation cycle determining unit 240 may set the cycle for credit value determination of the user equipment to a fixed value. For example, the user equipment may periodically report state information of the user equipment, and the calculation cycle determining unit 240 may set the cycle for credit value determination of the user equipment to be equal to a reporting cycle of the user equipment or an integral multiple of the reporting cycle. In this case, the calculation cycle determining unit 240 may set the cycle for credit value determination of all user equipments to a same value.

According to an embodiment of the present disclosure, the calculation cycle determining unit 240 may set the cycle for credit value determination of the user equipment to a variable value. For example, the electronic device 200 may periodically receive, from the user equipment through the communication unit 250, state information of the user equipment including a location and transmission power of the user equipment. Further, the calculation cycle determining unit 240 may set the cycle for credit value determination of the user equipment based on a change of the location of the user equipment and/or a change of the transmission power of the user equipment.

According to an embodiment of the present disclosure, in a case that neither the location nor the transmission power of the user equipment changes during N consecutive reporting cycles, the calculation cycle determining unit 240 may increase the cycle for credit value determination of the user equipment. Here, N is a positive integer, preferably equal to 2, 3 or 4. Further, increasing the cycle for credit value determination of the user equipment may include doubling the cycle for credit value determination of the user equipment. Apparently, the cycle for credit value determination cannot be infinitely increased, and the calculation cycle determining unit 240 may set a maximum value of the cycle for credit value determination, for example, to 8 times an initial value. For example, assuming that the initial value of the cycle for credit value determination is A, then: in a case that neither the location nor the transmission power of the user equipment changes during N consecutive reporting cycles, the calculation cycle determining unit 240 may determine the cycle for credit value determination as 2A; in a case that neither the location nor the transmission power of the user equipment changes during next N consecutive reporting cycles, the calculation cycle determining unit 240 may determine the cycle for credit value determination as 4A; in a case that neither the location nor the transmission power of the user equipment changes during next N consecutive reporting cycles, the calculation cycle determining unit 240 may determine the cycle for credit value determination as 8A; and then in a case that neither the location nor the transmission power of the user equipment changes during next N consecutive reporting cycles, the calculation cycle determining unit 240 still determines the cycle for credit value determination as 8A.

According to an embodiment of the present disclosure, in a case that the location of the user equipment or the transmission power of the user equipment changes during N consecutive cycles, the calculation cycle determining unit 240 may reduce the cycle for credit value determination of the user equipment. Here, N is a positive integer, preferably equal to 2, 3 or 4. For example, in a case of N=2, a situation belonging to that the location of the user equipment or the transmission power of the user equipment changes during N consecutive cycles may be that: the location of the user equipment changes while the transmission power of the user equipment does not change during a first cycle; and the transmission power of the user equipment changes while the location of the user equipment does not change during a second cycle. Further, a process of reducing the cycle for credit value determination of the user equipment may include: changing the cycle for credit value determination of the user equipment to half of an original cycle for credit value determination. Apparently, the cycle for credit value determination cannot be reduced infinitely, and the calculation cycle determining unit 240 may set a minimum value of the cycle for credit value determination, for example, to ⅛ of an initial value. For example, assuming that the initial value of the cycle for credit value determination is A, then: in a case that there is the location or the transmission power of the user equipment changes during N consecutive reporting cycles, the calculation cycle determining unit 240 may determine the cycle for credit value determination as A/2; in a case that there is the location or the transmission power of the user equipment changes during next N consecutive reporting cycles, the calculation cycle determining unit 240 may determine the cycle for credit value determination as A/4; in a case that there is the location or the transmission power of the user equipment changes during further next N consecutive reporting cycles, the calculation cycle determining unit 240 may determine the cycle for credit value determination as A/8; and then in a case that there is the location or the transmission power of the user equipment changes during further next N consecutive reporting cycles, the calculation cycle determining unit 240 still determines the cycle for credit value determination as A/8.

As described above, according to an embodiment of the present disclosure, the cycle for credit value determination may be set to a fixed value for an easy management, or may be set to a variable value to be updated based on changes of state information of the user equipment, so as to avoid unnecessary update steps and obtain a more reasonable value of the cycle for credit value determination.

According to an embodiment of the present disclosure, in a case that the credit value calculated by the credit value calculating unit 210 is less than the credit value threshold of the user equipment, the punishment unit 220 may restrict spectrum use of the user equipment during a punishment cycle, that is, punish the user equipment. In other words, in each cycle for credit value determination of the user equipment, the credit value calculating unit 210 updates the credit value of the user equipment, and the punishment unit 220 determines, based on a relationship between the updated credit value and the credit value threshold of the user equipment, whether to restrict the spectrum use of the user equipment.

According to an embodiment of the present disclosure, the punishment unit 220 may perform, during a punishment cycle, at least one of: reducing a transmission power of the user equipment; switching a channel of the user equipment; and rejecting the user equipment from using a spectrum resource. That is, a process of restricting spectrum use of the user equipment or punishing the user equipment includes at least one of the above.

According to an embodiment of the present disclosure, in a case that the channel quality of the user equipment is greater than or equal to the channel quality threshold of the user equipment, the punishment unit 220 may reduce the transmission power of the user equipment. As mentioned above, the electronic device 200 may receive, from the user equipment, the channel quality measured by the user equipment, and determine the channel quality threshold of the user equipment based on a traffic type of the user equipment, so that the punishment unit 220 may determine the relationship between the channel quality of the user equipment and the channel quality threshold of the user equipment. Further, the punishment unit 220 may reduce the transmission power of the user equipment by one power level each time based on a level of the transmission power of the user equipment, which is not limited in the present disclosure.

According to an embodiment of the present disclosure, in a case that the channel quality of the user equipment is less than the channel quality threshold of the user equipment, the punishment unit 220 may switch a channel of the user equipment or reject the user equipment from using a spectrum resource.

According to an embodiment of the present disclosure, in the case that the channel quality of the user equipment is less than the channel quality threshold of the user equipment, the punishment unit 220 may determine, with a certain probability, to switch a channel of the user equipment, where the probability may be 50%, for example. For example, the punishment unit 220 may generate a random number ε₁ that follows a uniform distribution from 0 to 1, compare ε₁ with a discrimination threshold γ₁ (preferably 0.5), and determine to switch the channel of the user equipment in a case of ε₁>γ₁.

According to an embodiment of the present disclosure, the user equipment may be randomly switched to another channel. In this case, the punishment unit 220 may notify only that the channel of the user equipment needs to be switched, and the user equipment determines which channel to be switched to. In another example, the punishment unit 220 may designate a channel to which the user equipment needs to be switched. For example, the punishing unit 220 may determine a channel by which the credit value of the user equipment would be increased to a maximum extent, and the user equipment is then switched to the determined channel. In this case, the punishment unit 220 is required to notify the user equipment of the designated channel.

According to an embodiment of the present disclosure, in a case that the punishment unit 220 determines not to switch the channel of the user equipment, the punishment unit 220 may determine, with a certain probability, to reject the user equipment from using a spectrum resource managed by the electronic device 200, where the probability is much less than 50%, such as 0.1% to 0.5%. For example, the punishment unit 220 may generate a random number ε₂ that follows a uniform distribution in a range of [0, 1], and compare ε₂ with a discrimination threshold γ₂ (preferably in a range from 0.001 to 0.005). In a case of ε₂<γ₂, the punishment unit 220 may determine to reject the user equipment from using the spectrum resource, that is, to remove the user equipment from a communication system.

According to an embodiment of the present disclosure, the user equipment may be rejected, with a pretty low probability, from accessing to a system. In this way, some user equipment may be appropriately removed from an area with high density of user equipment, so as to reduce interference between user equipments in the area.

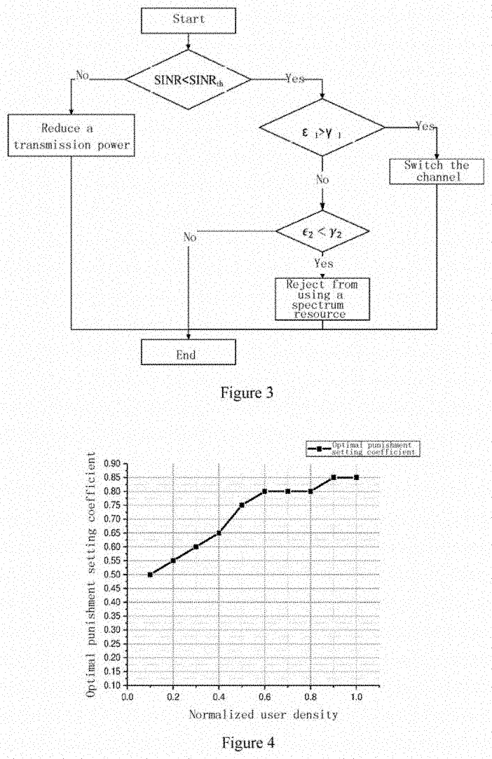

FIG. 3 is a schematic diagram showing a process of determining a punishment according to an embodiment of the present disclosure. As shown in FIG. 3, in a case that the channel quality SINR of the user equipment is greater than or equal to the channel quality threshold SINRₜₕ of the user equipment, the transmission power of the user equipment may be reduced. In a case that the channel quality SINR of the user equipment is less than the channel quality threshold SINRₜₕ of the user equipment, a relationship between a random number ci ranging from 0 to 1 and a discrimination threshold γ₁ is determined. In a case of ε₁>γ₁, the channel of the user equipment is switched. Further, in a case of ε₁≤γ₁, a relationship between a random number ε₂ and a discrimination threshold γ₂ is determined. In a case of ε₂<γ₂, the user equipment is rejected from using a spectrum resource. As shown in FIG. 3, the user equipment is not punished in a case of SINR<SINRₜₕ, ε₁≥γ₂ and ε₁≤γ₁. In this case, although the user equipment is not punished during the current cycle for credit value determination, the user equipment is likely to be punished in a next cycle for credit value determination as the credit value of the user equipment is low.

According to an embodiment of the present disclosure, as shown in FIG. 2, the electronic device 200 may further include a threshold determining unit 260 for determining a credit value threshold of the user equipment.

According to an embodiment of the present disclosure, the threshold determining unit 260 may set the credit value threshold of the user equipment to a fixed value. In addition, the threshold determining unit 260 may set the credit value threshold of each user equipment to a same value. Alternatively, the threshold determining unit 260 may determine the credit value threshold of the user equipment as a variable value.

According to an embodiment of the present disclosure, the threshold determining unit 260 may determine the credit value threshold of the user equipment based on the credit value of other user equipment within a predetermined range. For example, the threshold determining unit 260 may determine the credit value threshold of the user equipment based on an average of credit values of all other user equipments within the predetermined range. As described above, the predetermined range around the user equipment may be determined by the range determining unit 230, and the credit values of all other user equipments within the predetermined range may be calculated by the credit value calculating unit 210, so that the credit value threshold of the user equipment may be determined by the threshold determining unit 260 based on an average of the credit values of all other user equipments within the predetermined range.

Specifically, the threshold determining unit 260 may determine the credit value threshold of the user equipment by multiplying the average by a punishment setting coefficient. Further, the threshold determining unit 260 may determine the punishment setting coefficient based on a density of the user equipment within the predetermined range. A greater user density within the predetermined range indicates a greater punishment setting coefficient, and the punishment setting coefficient is in a range of (0, 1].

For example, the threshold determining unit 260 may determine the credit value threshold of the user equipment based on a formula below:

Crₜₕ=β×Cr_{bm} (8)

In the equation, Crₜₕ represents the credit value threshold of the user equipment, β represents the punishment setting coefficient, and Cr_{b}m represents the average of the credit values of all other user equipment within the predetermined range.

FIG. 4 is a schematic diagram showing a relationship between a punishment setting coefficient and user density according to an embodiment of the present disclosure. In FIG. 4, the horizontal axis represents a normalized user density ranging from 0 to 1, and the vertical axis represents an optimal punishment setting coefficient. As shown in FIG. 4, a higher normalized user density indicates a higher optimal punishment setting coefficient.

As described above, according to an embodiment of the present disclosure, the credit value threshold of the user equipment may be determined based on a user density within a predetermined range and credit values of all other user equipment within the predetermined range, so that a quantity of user equipment whose spectrum use is restricted is indirectly determined, realizing a more reasonable spectrum management.

According to an embodiment of the present disclosure, the punishment unit 220 may restrict the spectrum use of the user equipment during a punishment cycle. That is, during the punishment cycle, the punishing unit 220 may reduce a transmission power of the user equipment, switch a channel of the user equipment, or reject the user equipment from using a spectrum resource. Further, according to an embodiment of the present disclosure, after the punishment cycle, the credit value calculating unit 210 may restore the credit value of the user equipment to an initial value, Cr₀, of the credit value of the user equipment.

According to an embodiment of the present disclosure, as shown in FIG. 2, the electronic device 200 may further include a punishment cycle determining unit 270 for determining a punishment cycle of the user equipment.

According to an embodiment of the present disclosure, the punishment cycle determining unit 270 may determine the punishment cycle of the user equipment as a fixed value. For example, the punishment cycle determining unit 270 may determine the punishment cycle of each user equipment as a same fixed value. Alternatively, the punishment cycle determining unit 270 may determine the punishment cycle of a user equipment as a value fixed to the user equipment. For example, the punishment cycle of a specific user equipment may be 10 times to 15 times the cycle for credit value determination of the user equipment. In another example, the punishment cycle determining unit 270 may determine the punishment cycle of the user equipment as a variable value.

According to an embodiment of the present disclosure, the punishment cycle determining unit 270 may determine the punishment cycle of the user equipment based on the credit value of the user equipment and the credit value threshold of the user equipment. For example, the punishment cycle determining unit 270 may determine the punishment cycle of the user equipment based on a difference between the credit value threshold of the user equipment and the credit value of the user equipment. Specifically, a greater difference between the credit value threshold of the user equipment and the credit value of the user equipment corresponds to a longer punishment cycle set by the punishment cycle determining unit 270.

In a non-limiting example, the punishment cycle determining unit 270 determines the punishment cycle as:

Tₚ=α log(Crₜₕ−Crᵢ) (9)

In the equation, Tₚ represents the punishment cycle of the user equipment; a represents a punishment factor, which is a quantification factor for calculating a decrease of an overall system utility due to a decrease of the credit value, and is determined by the electronic device 200, ranges from 1 to 600, and in a unit of seconds; Crₜₕ represents the credit value threshold of the user equipment; and Crᵢ represents the credit value of the user equipment in the i-th cycle for credit value determination.

As described above, the punishment cycle determining unit 270 may reasonably set the punishment cycle according to the difference between the credit value and the credit value threshold of the user equipment, so that a more serious selfish behavior of the user equipment indicates a longer punishment cycle.

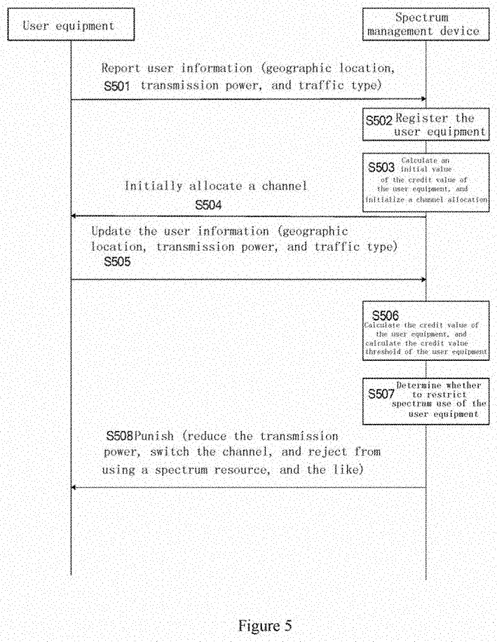

FIG. 5 is a diagram showing a signaling flow in a process of spectrum management according to an embodiment of the present disclosure. In FIG. 5, the spectrum management device may be implemented by the electronic device 200. As shown in FIG. 5, in step S501, a user equipment reports, to the spectrum management device, user status information including a geographic location, a transmission power, a traffic type, and other information of the user equipment. Next, in step S502, the spectrum management device registers the user equipment. In step S503, the spectrum management device determines an initial value of the credit value of the user equipment based on the transmission power, the traffic type and the transmission distance, and initializes a channel allocation for the user equipment. Next, in step S504, the spectrum management device allocates a channel to the user equipment. Next, in step S505, the user equipment periodically reports its status information, which still includes the geographic location, the transmission power, the traffic type and other parameters. Next, in step S506, in a next cycle for credit value determination, the spectrum management device calculates the credit value of the user equipment, and determines the credit value threshold of the user equipment based on the credit value of other user equipment within the predetermined range. Next, in step S507, the spectrum management device determines, based on the credit value of the user equipment and the credit value threshold of the user equipment, whether to restrict spectrum use of the user equipment. In a case that it is determined that the spectrum use of the user equipment needs to be restricted, the spectrum management device performs, in step S508, punishment during the punishment cycle, where the punishment includes reducing the transmission power of the user equipment, switching the channel of the user equipment, rejecting the user equipment from using a spectrum resource, or the like. After the punishment cycle, the spectrum management device restores the credit value of the user equipment to the initial value. Next, in a next cycle for credit value determination, the spectrum management equipment may recalculate the credit value of the user equipment and perform steps S506 to S508 in sequence. As shown in FIG. 5, the spectrum management device quantifies the spectrum use behavior of the user equipment, and restricts the spectrum use behavior of the user equipment when necessary.

It can be seen that, according to the embodiments of the present disclosure, the electronic device 200 may determine a credit value of a user equipment based on channel quality of the user equipment and interference caused by the user equipment to other user equipment within a predetermined range, so as to quantify a spectrum use behavior of the user equipment. Further, the electronic device 200 may determine, based on a relationship between the credit value and a credit value threshold, whether to restrict a spectrum use behavior of the user equipment. In this way, the spectrum use behavior of the user equipment may be managed and controlled. In addition, the user equipment may periodically report status information, and the electronic device 200 may update the credit value of the user equipment in accordance with the cycle for credit value determination, and punish the user equipment within a punishment cycle. With the present disclosure, the cycle for credit value determination, the punishment cycle, and the credit value threshold may be set reasonably, so that the spectrum use behavior may be managed and controlled in a standardized manner.

### 3. METHOD EMBODIMENTS

A wireless communication method performed by the electronic device 200 serving as a spectrum management device in a wireless communication system according to an embodiment of the present disclosure is described in detail below.

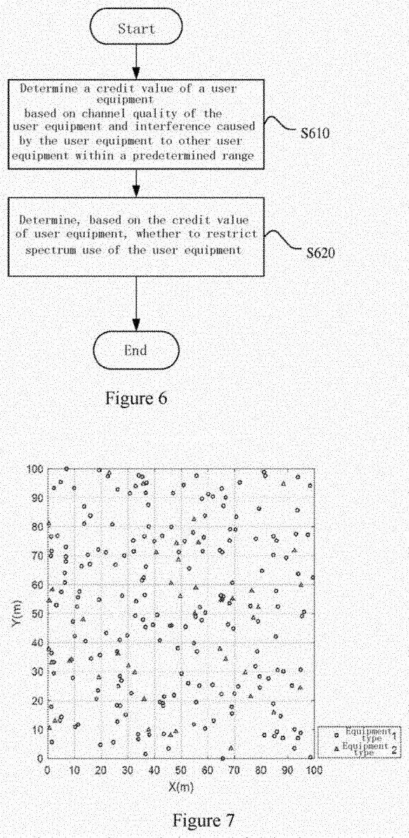

FIG. 6 is a flowchart showing a wireless communication method performed by electronic device 200 in a wireless communication system according to an embodiment of the present disclosure.

As shown in FIG. 6, in step S610, a credit value of user equipment is determined based on channel quality of the user equipment and interference caused by the user equipment to other user equipment within a predetermined range.

Next, in step S620, it is determined, based on the credit value of the user equipment, whether to restrict spectrum use of the user equipment.

In a preferred embodiment, a process of determining the credit value of the user equipment includes: determining a decrease value of the credit value based on the channel quality of the user equipment and the interference caused by the user equipment to the other user equipment within the predetermined range; and determining a credit value of the user equipment in a current cycle for credit value determination based on a credit value of the user equipment in a previous cycle for credit value determination and the decrease value.

In a preferred embodiment, the wireless communication method further includes: determining an initial value of the credit value of the user equipment based on at least one of the following parameters of the user equipment: a transmission distance, a transmission power, and a traffic type.

In a preferred embodiment, a process of determining the credit value of the user equipment includes: determining a channel quality difference based on a difference between the channel quality of the user equipment and a channel quality threshold of the user equipment; and determining the decrease value of the credit value of the user equipment based on the channel quality difference and the interference caused by the user equipment to the other user equipment within the predetermined range.

In a preferred embodiment, a process of determining the credit value of the user equipment includes: determining, based on a difference between the channel quality of the other user equipment when not suffering from the interference by the user equipment and the channel quality of the other user equipment when suffering from the interference by the user equipment, the interference caused by the user equipment to the other user equipment.

In a preferred embodiment, a process of determining the credit value of the user equipment includes: determining, based on an actual period of spectrum use of the user equipment and a threshold period of spectrum use, a probability that the credit value in the current cycle for credit value determination is equal to the credit value in the previous cycle for credit value determination.

In a preferred embodiment, a process of determining the probability includes: determining, in a case where the actual period of spectrum use of the user equipment is greater than or equal to the threshold period of spectrum use, that the probability is zero.

In a preferred embodiment, a process of determining the probability includes: determining, in a case where the actual period of spectrum use of the user equipment is less than the threshold period of spectrum use, the probability based on a ratio of the actual period of spectrum use of the user equipment to the threshold period spectrum use.

In a preferred embodiment, the wireless communication method further includes: determining the predetermined range based on the transmission power of the user equipment.

In a preferred embodiment, the wireless communication method further includes: setting the cycle for credit value determination of the user equipment to a fixed value.

In a preferred embodiment, the wireless communication method further includes: periodically receiving a location of the user equipment and a transmission power of the user equipment from the user equipment; and setting the cycle for credit value determination of the user equipment based on a change in the location and/or the transmission power of the user equipment.

In a preferred embodiment, a process of setting the cycle for credit value determination of the user equipment includes: increasing the cycle for credit value determination of the user equipment in response to neither the location nor the transmission power of the user equipment changing during N consecutive cycles; and reducing the cycle for credit value determination of the user equipment in response to the location or the transmission power of the user equipment changing during N consecutive cycles, where N is a positive integer.

In a preferred embodiment, a process of determining whether to restrict the spectrum use of the user equipment includes: restricting the spectrum use of the user equipment during a punishment cycle in response to the credit value of the user equipment being less than the credit value threshold of the user equipment.

In a preferred embodiment, a process of restricting the spectrum use of the user equipment includes performing, during the punishment cycle, at least one of: reducing the transmission power of the user equipment; switching a channel of the user equipment; and rejecting the user equipment from using a spectrum resource.

In a preferred embodiment, the wireless communication method further includes: reducing the transmission power of the user equipment in a case that the channel quality of the user equipment is greater than or equal to the channel quality threshold of the user equipment; and switching the channel of the user equipment or rejecting the user equipment from using a spectrum resource in a case that the channel quality of the user equipment is less than the channel quality threshold of the user equipment.

In a preferred embodiment, the wireless communication method further includes: determining the credit value threshold of the user equipment based on the credit values of other user equipment within the predetermined range.

In a preferred embodiment, the wireless communication method further includes: determining the punishment cycle of the user equipment based on the credit value of the user equipment and the credit value threshold of the user equipment.

In a preferred embodiment, the wireless communication method further includes: restricting the spectrum use of the user equipment during the punishment cycle when restricting the spectrum use of the user equipment; and restoring, after the punishment cycle, the credit value of the user equipment to the initial value of the credit value of the user equipment.

According to an embodiment of the present disclosure, a subject that performs the above-mentioned method may be the electronic device 200 according to the embodiments of the present disclosure, and therefore all embodiments above regarding the electronic device 200 are applicable thereto.

### 4. SIMULATION RESULTS

FIG. 7 is a schematic diagram showing a simulation scenario according to an embodiment of the present disclosure. Both the horizontal axis and the vertical axis in FIG. 7 represent geographic locations, which are in a unit of meters. As shown in FIG. 7, the simulation scenario of the present disclosure is set as a rectangular area of 100 meters×100 meters, in which two types of user equipment are evenly distributed. The user equipment of type 1 and the user equipment of type 2 are different in terms of transmission distance, maximum transmission power, initial transmission power, signal to interference plus noise ratio threshold, or other parameters. Simulation parameters of the present disclosure are shown in the table below.

| Simulation parameter | Parameter value | | | |
|---|---|---|---|---|
| Simulation area | 100 m × 100 m | | | |
| Center frequency | 3.6 | | GHz | |
| Number of channels | 15 | | | |
| Noise Power Spectral Density | −174 | | dBm/Hz | |
| Path Loss Index | 3.5 | | | |
| Channel bandwidth | 1 | | MHz | |
| Maximum transmission power | 10 | dBm | 20 | dBm |
| Initial transmission power | 10 | dBm | 20 | dBm |
| Signal to interference plus | 10 | dB | 15 | dB |

noise ratio threshold

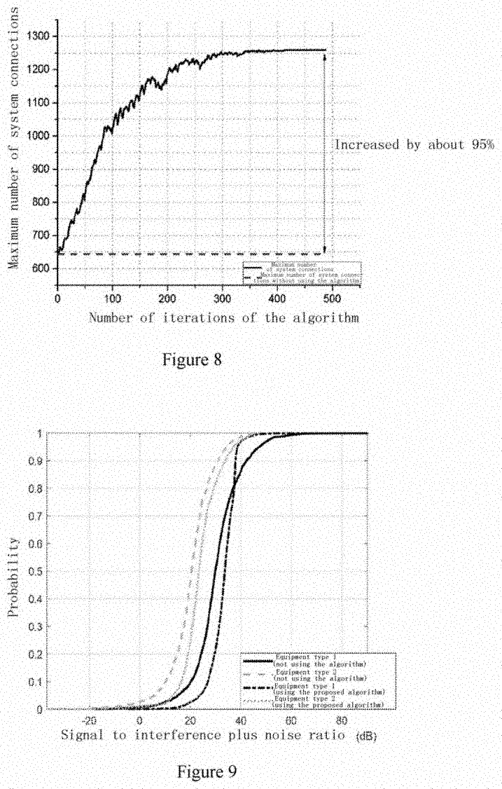

FIG. 8 is a schematic diagram showing a simulation curve of the maximum number of connections of the system versus the number of iterations of an algorithm according to an embodiment of the present disclosure. In FIG. 8, the solid curve shows changes of the maximum number of connections in the system as a function of the number of iterations of the algorithm when using the spectrum management scheme according to the present disclosure, and the dotted curve shows changes of the maximum number of connections in the system as a function of the number of iterations of the algorithm when not using the spectrum management scheme according to the present disclosure. Here, the maximum number of connections in the system indicates the maximum number of user connections supported by the system. It can be seen from FIG. 8 that with the iteration of the algorithm, the maximum number of connections supported by the system gradually increases and tends to be stable finally. Further, by using the spectrum management scheme according to the present disclosure, the maximum number of connections in the system is increased by about 95% compared with a situation not using the spectrum management scheme according to the present disclosure.

FIG. 9 is a schematic diagram showing simulation curves of a cumulative distribution function of signal to interference plus noise ratio of user equipment according to an embodiment of the present disclosure. In FIG. 9, the horizontal axis represents the signal to interference plus noise ratio in a unit of dB, and the vertical axis represents the probability. In FIG. 9, two dark curves show cases corresponding to a user equipment of type 1, and two light curves show cases corresponding to a user equipment of type 2. Specifically, the solid dark curve shows an SINR cumulative distribution function of the user equipment of type 1 in a case of not using the spectrum management scheme according to the present disclosure, and the dotted dark curve shows the SINR cumulative distribution function of the user equipment of type 1 in a case of using the management scheme spectrum according to the present disclosure. The dotted light curve with scattered dots shows the SINR cumulative distribution function of the user equipment of type 2 in a case of not using the spectrum management scheme according to the present disclosure, and the dotted light curve with dense dots shows the SINR cumulative distribution function of the user equipment of type 2 in the case of using the spectrum management scheme according to the present disclosure. It can be seen from FIG. 9 that after using the spectrum management scheme according to the present disclosure, an average signal to interference plus noise ratio is improved for both the user equipment of type 1 and the user equipment of type 2. This is because that the user equipment may choose to transmit with a maximum power due to selfish characteristics thereof in a case of not applying the spectrum management scheme according to the present disclosure; however, the selfish behavior of the user equipment is effectively suppressed when the spectrum management scheme according to the present disclosure is applied, and therefore interference in the system is reduced.

To sum up, it can be seen from the simulation results that after using the spectrum management scheme according to the present disclosure, the average signal to interference noise ratio of the user equipment is improved, and the maximum number of connections in the system is also increased. In a word, with the electronic device, the wireless communication method and the computer-readable storage medium according to the present disclosure, a quantitative evaluation may be performed on a spectrum use behavior of a user equipment in a process of spectrum sharing, so as to perform refined management and control on a behavior of the user equipment, and thereby reduce interference between a user equipment to another and improve an overall system utility.

### 5. APPLICATION EXAMPLE

The technology of the present disclosure is applicable to various products.

For example, the electronic device 200 may be implemented as any type of server, such as a tower server, a rack server, or a blade server. The electronic device 200 may be a control module mounted on a server (such as an integrated circuit module including a single wafer, and a card or blade inserted into a slot of a blade server).

The electronic device 200 may be disposed in a network side device. The network side device may be implemented as any type of base station device, such as a macro eNB or a small eNB, and may be implemented as any type of gNB (a base station in a 5G system). The small eNB may be an eNB covering a cell smaller than a macro cell, such as a pico eNB, a micro eNB, or a home (femto) eNB. Alternatively, the base station may be implemented as any other type of base station, such as a NodeB or a base transceiver station (BTS). The base station may include a body (which is also referred to as a base station device) configured to control wireless communication and one or more remote radio heads (RRHs) that are arranged in a different place from the body.

The user equipment may be implemented as a mobile terminal (such as a smartphone, a tablet personal computer (PC), a notebook PC, a portable game terminal, a portable/dongle-type mobile router, and a digital camera), or an in-vehicle terminal (such as a car navigation device). The user equipment may also be implemented as a terminal that performs machine-to-machine (M2M) communication (which is also referred to as a machine type communication (MTC) terminal). In addition, the user equipment may be a wireless communication module (such as an integrated circuit module including a single wafer) installed on each of the user equipment described above.

### Application Examples of a Server

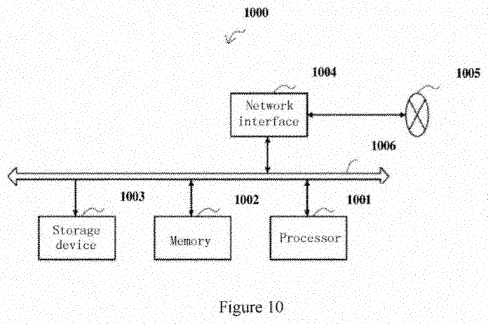

FIG. 10 is a block diagram showing an example of a server 1000 that may implement the electronic device 200 according to the present disclosure. The server 1000 includes a processor 1001, a memory 1002, a storage device 1003, a network interface 1004, and a bus 1006.

The processor 1001 may be, for example, a central processing unit (CPU) or a digital signal processor (DSP), and controls functions of the server 1000. The memory 1002 includes random access memory (RAM) and read only memory (ROM), and stores data and programs executed by the processor 1001. The storage device 1003 may include a storage medium, such as a semiconductor memory and a hard disk.

The network interface 1004 is a wired communication interface for connecting the server 1000 to a wired communication network 1005. The wired communication network 1005 may be a core network such as an Evolved Packet Core (EPC), or a Packet Data Network (PDN) such as the Internet.

The bus 1006 connects the processor 1001, the memory 1002, the storage device 1003, and the network interface 1004 to each other. The bus 1006 may include two or more buses having different speeds (such as a high-speed bus and a low-speed bus).

In the server 1000 shown in FIG. 10, the credit value calculating unit 210, the punishment unit 220, the range determining unit 230, the calculation cycle determining unit 240, the threshold determining unit 260 and the punishment cycle determining unit 270 described with reference to FIG. 2 may be implemented by the processor 1001, and the communication unit 250 described with reference to FIG. 2 may be implemented by the network interface 1004. For example, the processor 1001 may perform functions of calculating a credit value, restricting a spectrum use of a user equipment, determining an interference range of the user equipment, determining a cycle for calculating the credit value, determining a threshold of the credit value, and determining a punishment cycle, by executing instructions stored in the memory 1002 or the storage device 1003.

### Application Examples of a Base Station

### First Application Example

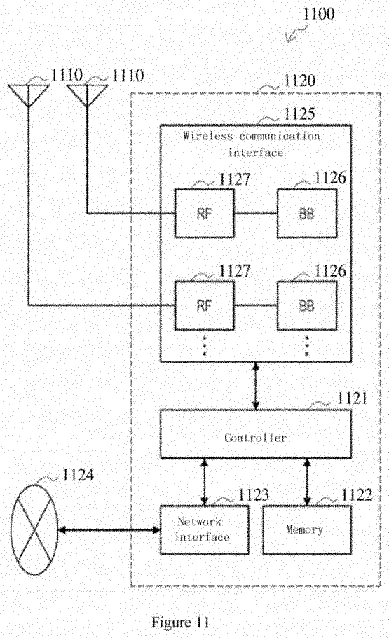

FIG. 11 is a block diagram showing a first example of a schematic configuration of an eNB to which the technique of the present disclosure may be applied. The eNB 1100 includes a single or multiple antennas 1110 and a base station device 1120. The base station device 1120 and each of the antennas 1110 may be connected to each other via a RF cable.

Each of the antennas 1110 includes a single or multiple antenna elements (such as multiple antenna elements included in a multiple-input multiple-output (MIMO) antenna), and are used for transmitting and receiving wireless signals by the base station device 1120. The eNB 1100 may include multiple antennas 1110, as shown in FIG. 11. For example, the multiple antennas 1110 may be compatible with multiple frequency bands used by the eNB 1100. Although FIG. 11 shows an example in which the eNB 1100 includes multiple antennas 1110, the eNB 1100 may include a single antenna 1110.

The base station device 1120 includes a controller 1121, a memory 1122, a network interface 1123, and a wireless communication interface 1125.

The controller 1121 may be, for example, a CPU or a DSP, and operates various functions of a higher layer of the base station device 1120. For example, the controller 1121 generates a data packet based on data in a signal processed by the wireless communication interface 1125, and transfers the generated packet via the network interface 1123. The controller 1121 may bundle data from multiple baseband processors to generate a bundled packet, and transfer the generated bundled packet. The controller 1121 may have logical functions of performing control such as radio resource control, radio bearer control, mobility management, admission control, and scheduling. The control may be performed in conjunction with an adjacent eNB or a core network node. The memory 1122 includes a RAM and a ROM, and stores a program executed by the controller 1121, and various types of control data (such as a terminal list, transmission power data, and scheduling data).

The network interface 1123 is a communication interface for connecting the base station device 1120 to a core network 1124. The controller 1121 may communicate with a core network node or another eNB via the network interface 1123. In this case, the eNB 1100, and the core network node or the other eNB may be connected to each other through a logical interface (such as an Si interface and an X2 interface). The network interface 1123 may be a wired communication interface or a wireless communication interface for a wireless backhaul line. In a case that the network interface 1123 is a wireless communication interface, the network interface 1123 may use a higher frequency band for wireless communication than a frequency band used by the wireless communication interface 1125.

The wireless communication interface 1125 supports any cellular communication scheme (such as Long Term Evolution (LTE) and LTE-Advanced), and provides wireless connection to a terminal positioned in a cell of the eNB 1100 via the antenna 1110. The wireless communication interface 1125 may typically include, for example, a baseband (BB) processor 1126 and an RF circuit 1127. The BB processor 1126 may perform, for example, coding/decoding, modulation/demodulation and multiplexing/de-multiplexing, and perform various types of signal processes of layers (for example, L1, media access control (MAC), radio link control (RLC) and packet data convergence protocol (PDCP)). Instead of the controller 1121, the BB processor 1126 may have a part or all of the above logical functions. The BB processor 1126 may be a memory storing a communication control program, or a module including a processor and a related circuit configured to execute the program. Updating the program may change the functions of the BB processor 1126. The module may be a card or a blade inserted into a slot of the base station device 1120. Alternatively, the module may be a chip mounted on the card or the blade. In addition, the RF circuit 1127 may include, for example, a frequency mixer, a filter or an amplifier, and transmits and receives wireless signals via the antenna 1110.

As shown in FIG. 11, the wireless communication interface 1125 may include multiple BB processors 1226. For example, the multiple BB processors 1226 may be compatible with multiple frequency bands used by the eNB 1100. As shown in FIG. 11, the wireless communication interface 1125 may include multiple RF circuits 1127. For example, the multiple RF circuits 1127 may be compatible with multiple antenna elements. Although FIG. 11 shows an example in which the wireless communication interface 1125 includes multiple BB processors 1126 and multiple RF circuits 1127, the wireless communication interface 1125 may include a single BB processor 1126 or a single RF circuit 1127.

### Second Application Example

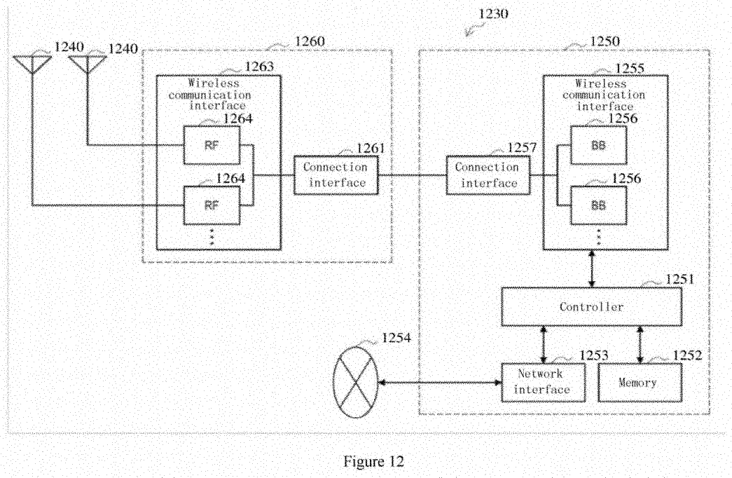

FIG. 12 is a block diagram showing a second example of a schematic configuration of an eNB to which the technique of the present disclosure may be applied. An eNB 1230 includes a single or multiple antennas 1240, a base station device 1250 and an RRH 1260. The RRH 1260 and the antennas 1240 may be connected to each other via an RF cable. The base station device 1250 and the RRH 1260 may be connected to each other via a high-speed line such as an optical fiber cable.

Each of the antennas 1240 includes a single or multiple antennal elements (such as multiple antenna elements included in a multiple-input multiple-output (MIMO) antenna), and is used for the RRH 1260 to transmit and receive wireless signals. As shown in FIG. 12, the eNB 1230 may include multiple antennas 1240. For example, the multiple antennas 1240 may be compatible with multiple frequency bands used by the eNB 1230. Although FIG. 12 shows an example in which the eNB 1230 includes multiple antennas 1240, the eNB 1230 may include a single antenna 1240.

The base station device 1250 includes a controller 1251, a memory 1252, a network interface 1253, a wireless communication interface 1255, and a connection interface 1257. The controller 1251, the memory 1252, and the network interface 1253 are the same as the controller 1121, the memory 1122, and the network interface 1123 described with reference to FIG. 11.

The wireless communication interface 1255 supports any cellular communication scheme (such as LTE and LTE-advanced), and provides wireless communication with a terminal located in a sector corresponding to the RRH 1260 via the RRH 1260 and the antenna 1240. The wireless communication interface 1255 may typically include, for example, a BB processor 1256. The BB processor 1256 is the same as the BB processor 1126 described with reference to FIG. 11, except that the BB processor 1256 is connected to an RF circuit 1264 of the RRH 1260 via the connection interface 1257. As show in FIG. 12, the wireless communication interface 1255 may include multiple BB processors 1256. For example, the multiple BB processors 1256 may be compatible with the multiple frequency bands used by the eNB 1230. Although FIG. 12 shows an example in which the wireless communication interface 1255 includes multiple BB processors 1256, the wireless communication interface 1255 may include a single BB processor 1256.

The connection interface 1257 is an interface for connecting the base station device 1250 (the wireless communication interface 1255) to the RRH 1260. The connection interface 1257 may be a communication module for communication in the above-described high speed line that connects the base station device 1250 (the wireless communication interface 1255) to the RRH 1260.

The RRH 1260 includes a connection interface 1261 and a wireless communication interface 1263.

The connection interface 1261 is an interface for connecting the RRH 1260 (the wireless communication interface 1263) to the base station device 1250. The connection interface 1261 may also be a communication module for communication in the above high-speed line.

The wireless communication interface 1263 transmits and receives wireless signals via the antenna 1240. The wireless communication interface 1263 may typically include, for example, the RF circuit 1264. The RF circuit 1264 may include, for example, a frequency mixer, a filter and an amplifier, and transmits and receives wireless signals via the antenna 1240. The wireless communication interface 1263 may include multiple RF circuits 1264, as shown in FIG. 12. For example, the multiple RF circuits 1264 may support multiple antenna elements. Although FIG. 12 shows the example in which the wireless communication interface 1263 includes multiple RF circuits 1264, the wireless communication interface 1263 may include a single RF circuit 1264.

In the eNB 1100 shown in FIG. 11 and the eNB 1230 shown in FIG. 12, the credit value calculating unit 210, the punishment unit 220, the range determining unit 230, the calculation cycle determining unit 240, the threshold determining unit 260 and the punishment cycle determining unit 270 described with reference to FIG. 2 may be implemented by the controller 1121 and/or the controller 1251. At least a part of the functions may be implemented by the controller 1121 and the controller 1251. For example, the controller 1121 and/or the controller 1251 may perform functions of calculating a credit value, restricting a spectrum use of a user equipment, determining an interference range of the user equipment, determining a cycle for calculating the credit value, determining a threshold of the credit value, and determining a punishment cycle, by executing instructions stored in a corresponding memory.

The preferred embodiments of the present disclosure are described above with reference to the drawings, but the present disclosure is not limited to the above examples. Those skilled in the art may make various alternations and modifications within the scope of the claims, and it should be understood that these alternations and modifications shall naturally fall within the technical scope of the present disclosure.

For example, a unit shown by a dashed box in the functional block diagram shown in the drawings indicates that the functional unit is optional in a corresponding device, and optional functional units may be combined with each other in an appropriate manner to achieve a desired function.

For example, multiple functions included in one unit in the above embodiments may be implemented by separate devices. Alternatively, multiple functions implemented by multiple units in the above embodiments may be implemented by separate devices, respectively. In addition, one of the above functions may be implemented by multiple units. Such configuration shall also be included in the technical scope of the present disclosure.

In this specification, the steps described in the flowchart include not only processes performed in time series as the order described, but also processes performed in parallel or individually instead of having to be performed in time series. Further, even in the steps processed in time series, the order may be appropriately changed.

Although the embodiments of the present disclosure have been described above in detail in connection with the drawings, it is appreciated that the embodiments as described above are merely illustrative rather than limitative for the present disclosure. Those skilled in the art may make various modifications and variations to the above embodiments without departing from the spirit and scope of the disclosure. Therefore, the scope of the disclosure is defined merely by the appended claims and their equivalents.

1. An electronic device, comprising processing circuitry configured to:
determine a credit value of a user equipment, based on channel quality of the user equipment and interference caused by the user equipment to other user equipment within a predetermined range; and
determine, based on the credit value of the user equipment, whether to restrict spectrum use of the user equipment.

2. The electronic device according to claim 1, wherein the processing circuitry is further configured to:
determine a decrease value of the credit value based on the channel quality of the user equipment and the interference caused by the user equipment to other user equipment within the predetermined range; and
determine the credit value of the user equipment in a current cycle for credit value determination, based on the credit value of the user equipment in a previous cycle for credit value determination and the decrease value.

3. The electronic device according to claim 2, wherein the processing circuitry is further configured to:
determine an initial value of the credit value of the user equipment based on at least one of the following parameters of the user equipment: a transmission distance, a transmission power, and a traffic type.

4. The electronic device according to claim 2, wherein the processing circuitry is further configured to:
determine a channel quality difference based on a difference between the channel quality of the user equipment and a channel quality threshold of the user equipment; and
determine the decrease value of the credit value of the user equipment based on the channel quality difference and the interference caused by the user equipment to other user equipment within the predetermined range.

5. The electronic device according to claim 2, wherein the processing circuitry is further configured to:
determine, based on a difference between the channel quality of the other user equipment when not suffering from the interference by the user equipment and the channel quality of the other user equipment when suffering from the interference by the user equipment, the interference caused by the user equipment to the other user equipment.

6. The electronic device according to claim 2, wherein the processing circuitry is further configured to:
determine, based on an actual period of spectrum use of the user equipment and a threshold period of spectrum use, a probability that the credit value in a current cycle for credit value determination is equal to the credit value in a previous cycle for credit value determination.

7. The electronic device according to claim 6, wherein the processing circuitry is further configured to:
determine, in a case where the actual period of spectrum use of the user equipment is greater than or equal to the threshold period of spectrum use, that the probability is zero.

8. The electronic device according to claim 6, wherein the processing circuitry is further configured to:
determine, in a case where the actual period of spectrum use of the user equipment is less than the threshold period of spectrum use, the probability based on a ratio of the actual period of spectrum use of the user equipment to the threshold period of spectrum use.

9. The electronic device according to claim 1, wherein the processing circuitry is further configured to:
determine the predetermined range based on a transmission power of the user equipment.

10. The electronic device according to claim 2, wherein the processing circuitry is further configured to:
set the cycle for credit value determination of the user equipment to a fixed value.

11. The electronic device according to claim 2, wherein the processing circuitry is further configured to:
receive, periodically from the user equipment, a location of the user equipment and a transmission power of the user equipment; and
set the cycle for credit value determination of the user equipment based on a change in the location of the user equipment and/or the transmission power of the user equipment.

12. The electronic device according to claim 11, wherein the processing circuitry is further configured to:
increase the cycle for credit value determination of the user equipment in response to neither the location of the user equipment nor the transmission power of the user equipment changing during N consecutive cycles; and
reduce the cycle for credit value determination of the user equipment in response to the location of the user equipment or the transmission power of the user equipment changing during N consecutive cycles,
wherein N is a positive integer.

13. The electronic device according to claim 1, wherein the processing circuitry is further configured to:
restrict the spectrum use of the user equipment during a punishment cycle in response to the credit value of the user equipment being less than a credit value threshold of the user equipment.

14. The electronic device according to claim 13, wherein the processing circuitry is further configured to: perform, when restricting the spectrum use of the user equipment during the punishment cycle, at least one of:
reducing a transmission power of the user equipment;
switching a channel of the user equipment; and
rejecting the user equipment from using a spectrum resource.

15. The electronic device according to claim 14, wherein the processing circuitry is further configured to:
reduce the transmission power of the user equipment in a case that the channel quality of the user equipment is greater than or equal to a channel quality threshold of the user equipment; and
switch a channel of the user equipment or reject the user equipment from using a spectrum resource, in a case that the channel quality of the user equipment is less than the channel quality threshold of the user equipment.

16. The electronic device according to claim 13, wherein the processing circuitry is further configured to:
determine the credit value threshold of the user equipment based on the credit value of other user equipment within the predetermined range.

17. The electronic device according to claim 13, wherein the processing circuitry is further configured to:
determine the punishment cycle of the user equipment based on the credit value of the user equipment and the credit value threshold of the user equipment.

18. The electronic device according to claim 3, wherein the processing circuitry is further configured to:
restrict the spectrum use of the user equipment during the punishment cycle when restricting the spectrum use of the user equipment; and
restore, after the punishment cycle, the credit value of the user equipment to the initial value of the credit value of the user equipment.

19. A wireless communication method, performed by an electronic device, comprising:
determining a credit value of a user equipment, based on channel quality of the user equipment and interference caused by the user equipment to other user equipment within a predetermined range; and
determining, based on the credit value of the user equipment, whether to restrict spectrum use of the user equipment.

20.-36. (canceled)

37. A non-transitory computer-readable storage medium comprising executable computer instructions, wherein the executable computer instructions, when executed by a computer, cause the computer to perform the wireless communication method according to claim 19.
